(19) United States
(12) Patent Application Publication
(10) Pub. No.: US 2018/0178408 A1
(43) Pub. Date: Jun. 28, 2018

(54) APPARATUS AND METHOD FOR CUTTING SLABS MADE OF PORCELAIN

(71) Applicant: GIBEN TECH S.R.L., Bologna (IT)

(72) Inventor: Piergiorgio BENUZZI, Bologna (IT)

(21) Appl. No.: 15/739,642

(22) PCT Filed: Jun. 29, 2016
(86) PCT No.: PCT/IB2016/053886

§ 371 Date: Dec. 22, 2017

(30) Foreign Application Priority Data
Jun. 29, 2015 (IT) 102015000028760

(51) Int. Cl. B28D 1/22; B28D 1/24

(52) U.S. Cl. CPC B28D 1/226; B28D 1/24

(57) ABSTRACT

An apparatus for cutting slabs made of porcelain or like materials includes a support and blocking plane of at least a slab, and at least a cutting group of the slab, arranged superiorly thereof. The cutting group includes rotary tools associated with a carriage mobile along a parallel direction to the support plane; a component for moving the rotary tools independently of one another, in a perpendicular direction to the parallel direction, between two end positions, respectively an active neared position for working on the slab and a non-active distanced position, raised from the slab.

### TECHNICAL FIELD

This invention relates to an apparatus for cutting slabs or panels made of porcelain or similar materials. The two definitions (slab or panel) are used as synonyms.

Porcelain is a particular type of ceramic, and for this reason is defined as a similar material.

Porcelain was originally produced in China, and then developed in Europe, giving rise, above all, to furnishing items, such as vases, plates, statues, etc. of particularly high quality and value.

What most defines this product are its hardness characteristics, even though accompanied by fragility, the quality of surface finishing, the possibility of making products with a very wide range of colours and patterns, as well as the long service life even if located outdoors, in the sunlight and adverse weather conditions.

### BACKGROUND ART

Production is currently carried out of panels or slabs of porcelain with large dimensions which are made for covering large surfaces, such as internal walls, floorings or even lining the walls of bathrooms or shower cubicles or outdoor finishing works, for example entire buildings, which thereby adopt, when the work is completed, a high quality appearance, combined with an unrivalled architectural appearance. In addition, there is the use in interior furnishing, for example for kitchen surfaces where resistance to heat, scratches and acidic substances is required.

The slabs are obtained by means of traditional methods, but they must be finished along the relative edges and cut to size, according to the applications and the results which one wishes to obtain.

Apparatus is not currently known which is equipped with a minimum automation that can perform that function, precisely because, until now, there was not the problem of cutting such high quantities and large sizes of porcelain parts.

In addition, there is also the fact that, due to the characteristics of hardness of the product, for the reasons mentioned above, the cutting is demanding.

To the knowledge of the Applicant, the operators in this field use simple manual devices, such as cutting tools, supported on lightweight guides for a feeding which is less dependent on manual operations by the operator, comprising a grinding wheel, usually diamond tipped, which is mounted on a rotary shaft supported and rotated by a relative motor; this is all shaped with a handle for gripping by the operator or for fixing on a support.

The cutting therefore occurs by manually feeding the device on the panel or slab.

The drawbacks can therefore be summed up as difficulty in making precise cuts, limited cutting speed and danger of the process, as it is of a manual type.

Currently, in fact, in certain cases, as well as using diamond grinding wheels, the slabs are trimmed or shaped using ball-end diamond cutters, clearly with extremely long execution times.

### DISCLOSURE OF THE INVENTION

The aim of this invention is to provide an apparatus for cutting slabs made of porcelain or like materials which overcomes the above-mentioned drawbacks of the prior art.

More specifically, the aim of this invention is to provide an apparatus for cutting slabs made of porcelain or similar materials which is capable of making cuts of the material with precision, at a speed which is without doubt suitable for the requested quantity and quality of production.

A further aim of this invention is to propose an apparatus for cutting slabs or panels made of porcelain or similar materials by which it is possible to use tools (grinding wheels) whose combination, in the cutting step, allows an increase in the service life of the tool and therefore a lower cost which would influence on the cutting and the final costs of the product/porcelain. A further aim of this invention is to provide an apparatus for cutting panels of porcelain or similar materials which operates with extremely high safety parameters for the operator.

A further aim of this invention is also the possibility of performing, simultaneously with the cut, operations for chamfering one or more upper and/or lower edges thanks to the use of a suitable grinding wheel(s) which, after the cutting step, but during the same working process, executes the chamfer(s) required, to the advantage of a very high speed of execution. The above aims are fully achieved by the apparatus and method according to the invention as characterised in the appended claims.

### BRIEF DESCRIPTION OF THE DRAWINGS

This and other features of the invention will become more apparent from the following description of a preferred embodiment of it, illustrated by way of non-limiting example in the accompanying drawings, in which:

FIG. 1 illustrates a first solution of the apparatus according to the invention through the succession of views from 1a to 1f;

FIG. 2 illustrates a second improved solution of the apparatus according to the invention through the succession of views from 2a to 2f;

FIG. 3 illustrates an enlarged view of the detail of the entry of the first tool on the slab to be processed;

FIG. 4 schematically illustrates the profile of a grinding tool for making bevels or chamfers on the part being processed.

### DETAILED DESCRIPTION OF PREFERRED EMBODIMENTS OF THE INVENTION

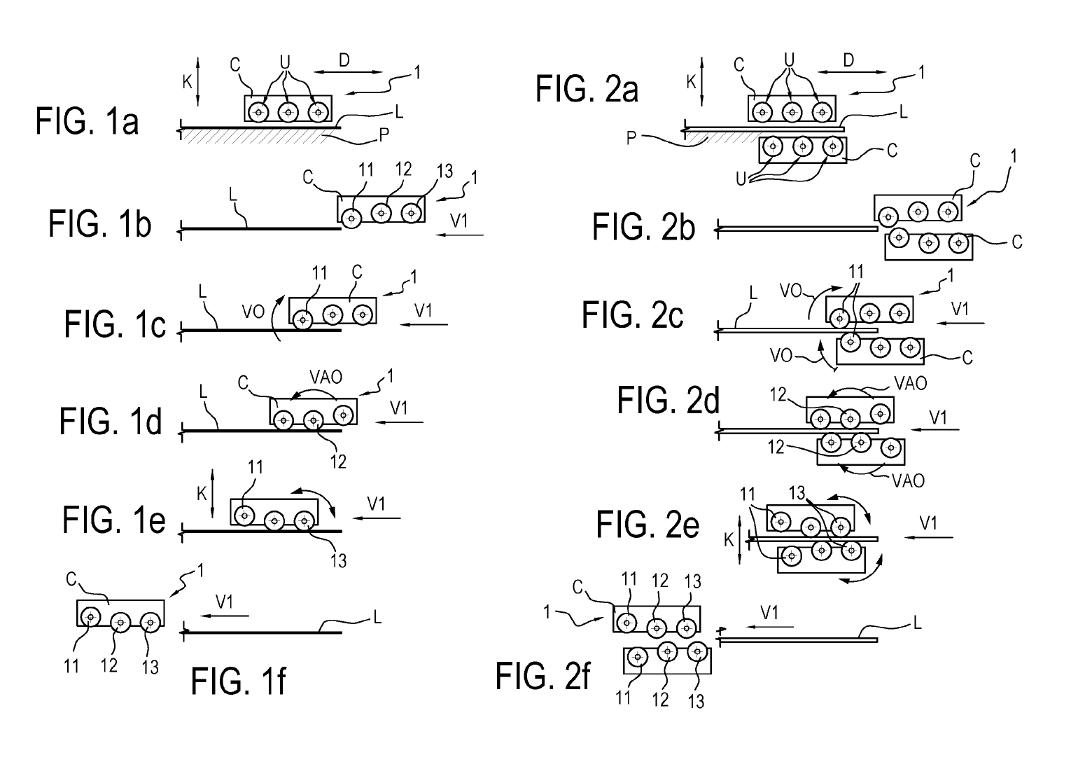

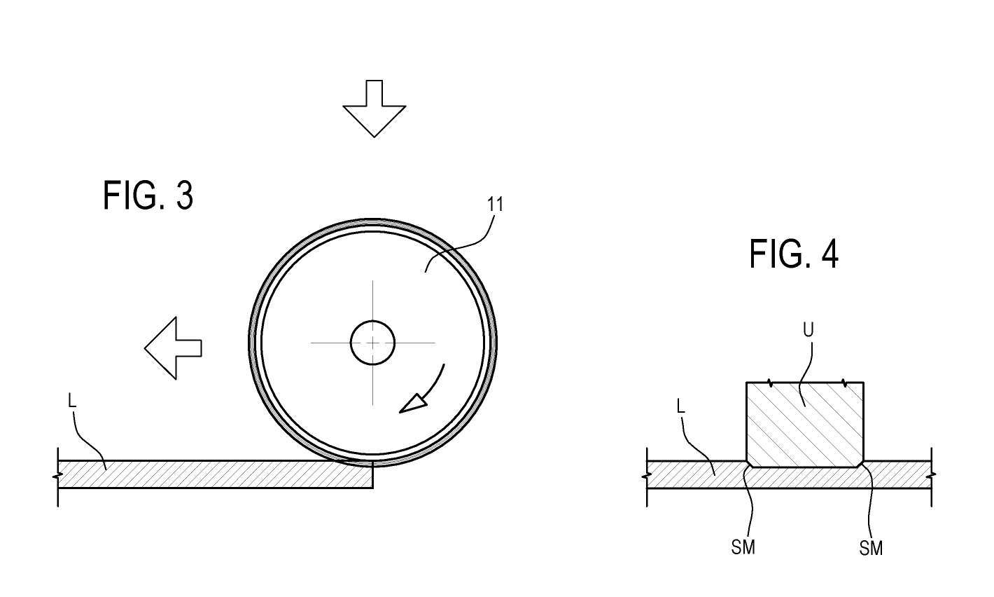

With reference to the accompanying drawings, it is assumed that the apparatus according to the invention can use only one (see FIG. 1) or a pair of cutting groups (see FIG. 2), each of which is denoted in the drawings with the numeral (1).

For convenience of description, reference will be made to the case of FIG. 1, in which a single cutting group is illustrated and used, which will again be denoted by numeral (1) and which is located above a plane (P) for supporting the product-slab (L) which is to undergo the cut.

The specific nature of the plane is not described here as it is of known type, which will be equipped with the respective and corresponding means which allow the fixing and stabilising of the slab to be cut on the same plane.

The group (1) is configured with a plurality of cutting tools (U), which in the case of FIGS. 1 and 2, are three in number and labelled, respectively, (11), (12), (13).

The rotating tools (U) are associated with a carriage (C) mobile along a direction (D) parallel to the support plane (P).

There are then means (generally indicated as, for example, since of known type, pneumatic cylinders or the like) for a movement of the tools (U), independently of each other, in a direction (K) perpendicular to the direction (D).

This movement occurs between two end positions, respectively an active neared position for working on the slab (L) and a non-active distanced position, raised from the slab.

The cutting tools are defined by grinding wheels or diamond discs, as they are known commercially.

They are positioned one after the other and on the same vertical cutting plane and are configured for performing, on the slab, a complementary incision and/or cutting action.

As be seen in the drawings, the direction of rotation of the tools has been conceived in such a way as to make a cut on the panel/slab which will not result in chipping or fracturing of the surfaces of the panel itself and in particular of its corners.

This need for quality of the cutting is felt particularly for this type of material, precisely, porcelain (ceramic), which has characteristics of fragility.

Again with reference to FIG. 1, the tool (11) will have a clockwise direction of rotation (VO), the next tool (12) will have an anticlockwise direction of rotation (VAO) and the last tool (13) will have a clockwise or anti-clockwise direction of rotation depending on the type of processing to be performed, as described in more detail below.

As well as this feature, each tool can move towards or away from the panel in the direction (K) (therefore becoming active or passive on the cut) independently of the others.

The use of a plurality of tools, in this case three, allows the following succession of steps during the process for cutting the slab or panel (L).

The carriage (C) (not illustrated in detail, since also of known type) for supporting the tools starts to move the latter in the direction (V1), see FIG. 1b, hence against the panel to be processed, with a single tool lowered in an active step, the first tool (11), and with the remaining tools (12) and (13) raised in a non-active step.

In this first step of attack on the panel, see FIG. 1c, the tool (11) makes an incision on the slab on the upper surface, when entering, and its direction of rotation has the purpose of not causing chipping when entering the panel/slab (L).

During the stroke of the carriage (C) the next tool, tool (12), is also inserted, once this has exceeded the point of entry on the slab, see FIG. 1d.

It should be noted that the first tool (11) will deactivate, lifting up, before its exit from the final part of the slab, having already performed its relative function of preventing chipping on entry into the slab.

Proceeding with the stroke of the carriage, the third tool (13) will also be activated, see FIG. 1e, completing the cutting. This drawing also shows the step of deactivating the first tool (11) which, as mentioned above, no longer has (or would not have) its main function.

It should be noted that the combination of the tools indicated above is a function of:
the first tool (11) acts as an incisor in such a way as to prevent, as already mentioned, problems of chipping when entering the slab;
the second tool (12) increases the incision, with particular care, in such a way as to prevent problems of chipping when exiting from the plate;
the third tool (13) carries out the proper cut, completing it over the entire thickness of the panel or slab. The direction of rotation of this third tool, not affecting the surfaces already processed, that is to say, incised, by the previous tools, will be chosen as a function of the variables involved, such as the nature of the slab, speed and depth of the cut, etc.

The subdivision of the duties made in this way allows the cutting speed to be increased considerably compared with traditional systems; and also the precision of the cut.

Another positive aspect of this subdivision of the cutting activities of the various tools, also produces less stress on the slab, as well as on the tool, that is to say, a greater service life, together with a greater speed and cutting precision.

The solution according to the invention also provides a method for cutting porcelain slabs (L), arranged on a support and blocking plane (P) of at least one slab (L), by means of at least one cutting group (1). comprising rotating tools (U) are associated with a carriage (C) mobile along a direction (D) parallel to the support plane (P); the tools (U) being mobile, independently of one another, in a perpendicular direction (K) to the direction (D), between two end positions, respectively an active neared position for working on the slab and a non-active distanced position, raised from the slab, the method comprising the following steps:
activating at least a first tool (11) configured, in the active neared position thereof, and having, where the carriage (C) moves in an entering direction (V1) on the slab to be worked, a clockwise rotation direction (VO) of attack on the panel, incising the slab on the upper surface thereof, in entry, with an aim of not causing chipping in entry on the slab; the second tool (12) being positioned in the distanced position thereof;
following entry on the slab by the first tool (11), activating at least a second tool (12) configured in the neared position thereof and having an anticlockwise rotation direction (VAO) with an aim of increasing the incision and the cut, so as to avoid chipping in an exit step of the second tool (12) from the slab, the tools (11) and (12) being successively positioned one following another and on the same vertical cutting plane, so as to carry out, on the slab, a complementary cutting action;
subsequent de-activation of the first tool (11) in the distanced position thereof.

According to the method, the cutting group (1) comprises a third tool (13) arranged downstream of the preceding tools with respect to the advancing direction (V1) and acting on the same vertical plane, by which it carries out, in the neared position thereof and with the entry achieved on the slab by the second tool (12), a cut, completing the cut for a whole thickness of the slab.

Where the thickness of the panel is limited or particularly high cutting speeds are not required, use may be made of a single pair of tools (11) and (12). In this case, the configuration of the apparatus would still be that illustrated in FIG. 1, but without the presence of the third tool (13). The operating steps would again be those described above, however leaving only tools (11) and (12) the duty of not only carrying out the function of incisors when entering and exiting (no chipping on the respective edges of attack), but also the function of actually cutting through the thickness of the slab (L).

Vice versa, where the thickness of the slab or the need to superpose more than one panel is significant (large production quantities), the cutting group (1) may be doubled, using a second group (which will again be indicated with the numeral (1) since it is similar to the first) positioned symmetrically beneath the first group and the supporting surface (P) of the panel, as shown in FIG. 2. Obviously, the directions of rotation of this second group will follow the laws of symmetry in compliance with the first upper group; moreover, it will have equal movements to the tools which, in any case, will be in synchrony with the advance of the first group, in such a way as to contribute to the cutting of the panel(s) to be processed.

It should be noted how the presence of a second cutting group, the lower one, will allow, even more easily, to adjust the thickness and/or the cross section shape of the tools, so as to obtain chamfers and/or countersinks during the cutting steps. This has been schematically illustrated in FIG. 4 which shows a tool (U) in cross section acting on the underlying panel or slab and which has a profile with a pair of the bevels (SM) which may make a corresponding bevelled cutting on the slab in its final configuration. Obviously, the choice of bevelled tools, as shown in FIG. 4, can extend both to the upper and lower cutting group according to the requirements.

To sum up the possible applications of the solution according to the invention, there are three macro categories which may make use of the apparatus or the method described, which are
1) the primary manufacturers of the slabs,
2) the stores which purchase these slabs and provide a service to their customers for semi-finished parts
3) the firms on the market in the field of installers for furnishing or supply to construction sites in general.

The three categories have similar needs and requirements but with specific cutting solutions where, for example,
the first category requires cutting machines which are very automatic in the movement, in terms of layout and, above all, speeds up the performance of the cut which, preferably, may be made carried out both from below and above, with the (three or more) grinding wheels in such a way that the production output is high;
the second category could be likened to the first or, if they have smaller dimensions, it could use only groups preferably from above, as well as with semiautomatic layout and movement;
the third category, typically for installers, may definitely use a machine with a single cutting group, preferably from above, of dimensions suitable for the measurements of the slabs which the market offers and also with the addition, if necessary, of other groups of grinding wheels/diamond cutters which can make bevelled edges in the two cut edges which may occur with the addition (use) of adequate grinding wheels or cutters in such a way that the finished product is ready to be delivered and installed in situ.

The invention therefore achieves the preset aims indicated above.

1-8. (canceled)

9. An apparatus for cutting slabs made of porcelain, comprising a support and blocking plane of at least one slab, and at least one cutting group of the slab, arranged superiorly thereof, and comprising rotary tools associated with a carriage mobile along a parallel direction to the support plane; means being included for moving the rotary tools, independently of one another, in a perpendicular direction to the parallel direction, between two end positions, respectively an active neared position for working on the slab and a non-active distanced position, raised from the slab, wherein the carriage comprises at least two of the rotary tools and arranged one following another and on a same vertical cutting plane and configured such as to carry out, on the slab, a complementary cutting action, in which:—a first rotary tool is configured, in the active neared position thereof, and has, where the carriage moves in an entering direction on the slab to be worked, a clockwise rotation direction of attack on the slab, incising the slab on the upper surface thereof, in entry, with an aim of not causing chipping in entry on the slab; a second rotary tool being positioned in the distanced position thereof;
following entry on the slab by the first rotary tool, the second rotary tool is configured in the neared position thereof, and has an anticlockwise rotation in an exit step of the second rotary tool from the slab, the first rotary tool being successively positioned in the distanced position thereof

10. The apparatus for cutting porcelain slabs according to claim 9, wherein the cutting group comprises a third rotary tool arranged downstream of the preceding tools with respect to the advancing direction and acting on the same vertical plane, configured so as to carry out, in the neared position thereof and with the entry achieved on the slab by the second rotary tool, a cut, completing the cut for a whole thickness of the slab.

11. The apparatus according to claim 10, wherein the third rotary tool has a clockwise rotation direction.

12. The apparatus according to claim 10, wherein the third rotary tool has an anticlockwise rotation direction.

13. The apparatus according to claim 9, further comprising a second cutting group having like characteristics to those of the first cutting group, symmetrically arranged below the first group and the support plane of the panel;
the first and the second group operating in combination and summing effects thereof on the cutting of the slab or panel.

14. The apparatus according to claim 9, wherein at least one of the rotary tools has a bevelled configuration in section.

15. A method for cutting porcelain slabs, arranged on a support and blocking plane of at least one slab, by means of at least one cutting group comprising rotary tools associated with a carriage mobile along a parallel direction to the support plane; the rotary tools being mobile, independently of one another, in a perpendicular direction to the parallel direction, between two end positions, respectively an active neared position for working on the slab and a non-active distanced position, raised from the slab, the method comprising the following steps:
activating at least a first rotary tool of said rotary tools, configured, in the active neared position thereof, and having, where the carriage moves in an entering direction on the slab to be worked, a clockwise rotation direction of attack on the slab, incising the slab on the upper surface thereof, in entry, with an aim of not causing chipping in entry on the slab; a second rotary tool of said rotary tools being positioned in the distanced position thereof;
following entry on the slab by the first rotary tool, activating at least a second rotary tool configured in the neared position thereof and having an anticlockwise rotation direction with an aim of increasing the incision and the cut, so as to avoid chipping in an exit step of the second rotary tool from the slab, the rotary tools and being successively positioned one following another and on the same vertical cutting plane, so as to carry out, on the slab, a complementary cutting action;
subsequent de-activation of the first rotary tool in the distanced position thereof

16. The method according claim 15, wherein the cutting group comprises a third rotary tool arranged downstream of the first and second tools with respect to the advancing direction and acting on the same vertical plane, and wherein it carries out, in the neared position thereof and with the entry achieved on the slab by the second rotary tool, a cut, completing the cut for a whole thickness of the slab.
